(19) United States
(12) Patent Application Publication
(10) Pub. No.: US 2021/0332796 A1
(43) Pub. Date: Oct. 28, 2021

(54) METHOD AND APPARATUS FOR ICING PREDICTION, METHOD AND APPARATUS FOR GENERATNG ICING PREDICTION MODEL

(71) Applicant: BEIJING GOLDWIND SCIENCE & CREATION WINDPOWER EQUIPMENT CO., LTD., Beijing (CN)

(72) Inventors: Jie ZHOU, Beijing (CN); Juan AO, Beijing (CN); Qingtian WANG, Beijing (CN)

(21) Appl. No.: 16/338,808

(22) PCT Filed: Apr. 10, 2018
(86) PCT No.: PCT/CN2018/082514

§ 371 Date: Apr. 2, 2019

(30) Foreign Application Priority Data
Dec. 14, 2017 (CN) 201711341540.6

(51) Int. Cl. F03D 17/00; G06N 5/04; G06N 20/00

(52) U.S. Cl. CPC F03D 17/00; G06N 20/00; G06N 5/04

(57) ABSTRACT

Provided are a method and an apparatus for icing prediction, and a method and an apparatus for generating an icing prediction model. The method for icing prediction includes: extracting a valid meteorological prediction data feature of a target wind turbine based on geographic information of the target wind turbine; inputting the valid meteorological prediction data feature into an icing prediction model for predict icing information; and outputting an icing prediction result by the icing prediction model in response to the input.

The present application is a national phase of international application No. PCT/CN2018/082514 filed on Apr. 10, 2018, which claims priority to Chinese Patent Application No. 201711341540.6, titled “METHOD AND APPARATUS FOR ICING PREDICTION, METHOD AND APPARATUS FOR GENERATING ICING PREDICTION MODEL”, filed on Dec. 14, 2017 with the Chinese Patent office, both of which are incorporated herein by reference in their entirety.

### FIELD

The present application relates to the field of wind power generation technologies, and in particular to a method and an apparatus for predicting icing, and a method and an apparatus for generating an icing prediction model.

### BACKGROUND

Icing on a wind turbine is always a traditional problem in the wind power industry, and is an important factor affecting the income of wind farms. Blades of the wind turbine bear a large ice load when the icing is serious, which may be a great threaten to lifetime of the blades and a safe operation of the wind turbine.

Therefore, how to accurately predict an icing condition of each wind turbine generator system is an urgent technical issue to be addressed.

### SUMMARY

Embodiments of the present application provides a method and an apparatus for predicting icing on a wind turbine generator system, a storage medium including the same, a method and an apparatus for generating an icing prediction model for a wind turbine generator system.

According to a first aspect, a method for predicting icing on a wind turbine generator system is provided according to an embodiment of the present application, the method includes:

extracting a valid meteorological prediction data feature of a target wind turbine based on geographic information of the target wind turbine;

inputting the valid meteorological prediction data feature into an icing prediction model for predicting icing information; and

outputting an icing prediction result by the icing prediction model in response to the input.

According to a second aspect, an apparatus for predicting icing on a wind turbine generator system is provided according to an embodiment of the present application, the apparatus includes:

an information extracting unit, configured to extract a valid meteorological prediction data feature of the target wind turbine based on geographic information of the target wind turbine;

an information input unit, configured to input the valid meteorological prediction data feature into an icing prediction model for predicting icing information; and

an information output unit, configured to output an icing prediction result by the icing prediction model in response to the input.

According to a third aspect, an apparatus for predicting icing on a wind turbine generator system is provided according to an embodiment of the present application, the apparatus includes: at least one processor, at least one memory storing a computer program, where the computer program when being executed by the processor, causes the processor to perform the method as described above in the first aspect.

According to a fourth aspect, a computer readable storage medium is provided according to an embodiment of the present application, where the computer readable storage medium stores a computer program, when being executed by a processor, causes the processor to perform the method as described above in the first aspect.

According to a fifth aspect, a method for generating ab icing prediction model for a wind turbine generator system is provided according to an embodiment of the present application, the method includes:

obtaining geographic information and historical icing flag information of the target wind turbine in a target wind farm;

obtaining a historical meteorological prediction data feature corresponding to the geographic information of the target wind turbine; and

establishing the icing prediction model for outputting predicted icing information based on input information including the historical meteorological prediction data feature and the historical icing flag.

According to a sixth aspect, an apparatus for generating an icing prediction model for a wind turbine generator system is provided according to an embodiment of the present application, the apparatus includes:

an information obtaining unit, configured to obtain geographic information and historical icing flag information of a target wind turbine in a target wind farm;

a feature obtaining unit, configured to obtain a historical meteorological prediction data feature of the target wind turbine corresponding to the geographic information; and

a model establishing unit, configured to establish the icing prediction model for outputting predicted icing information based on input information comprising the historical meteorological prediction data feature and the historical icing flag.

According to the embodiments of the present application, valid meteorological prediction data features of the target wind turbines at different geographical locations can be precisely extracted based on the geographic information of the target wind turbines. The precise valid meteorological prediction data feature of the target wind turbine is inputted into the icing prediction model, so that precise icing prediction results of the target wind turbines at different geographical locations can be outputted. Therefore, the icing information of the target wind turbine can be predicted with high precision according to embodiments of the present application, so that the operation and maintenance works for preventing icing on the wind turbines can be performed in a good time, thereby avoiding a potential economic loss caused by a passive icing treatment.

### BRIEF DESCRIPTION OF THE DRAWINGS

For a clear illustration of technical solutions of the present disclosure, drawings according to the embodiments are introduced briefly hereinafter. It should be noted that those skilled in the art can obtain other drawings without any creative work based on these drawings.

FIG. 1 is a schematic diagram of a method for generating an icing prediction model of a wind turbine generator system according to an embodiment of the present application;

FIG. 2 is a schematic diagram of obtaining a historical meteorological prediction data feature according to an embodiment of the present application;

FIG. 3 is a schematic diagram of a method for generating an icing prediction model of a wind turbine generator system according to another embodiment of the present application;

FIG. 4 is a schematic diagram of an method for predicting icing on wind turbine generator system according to an embodiment of the present application;

FIG. 5 is a structure schematic diagram of an apparatus for generating an icing prediction model of a wind turbine generator system according to an embodiment of the present application;

FIG. 6 is a structure schematic diagram of an apparatus for predicting icing on a wind turbine generator system according to an embodiment of the present application; and

FIG. 7 is a structure schematic diagram of an apparatus for predicting icing on a wind turbine generator system according to an embodiment of the present application.

### DETAILED DESCRIPTION OF EMBODIMENTS

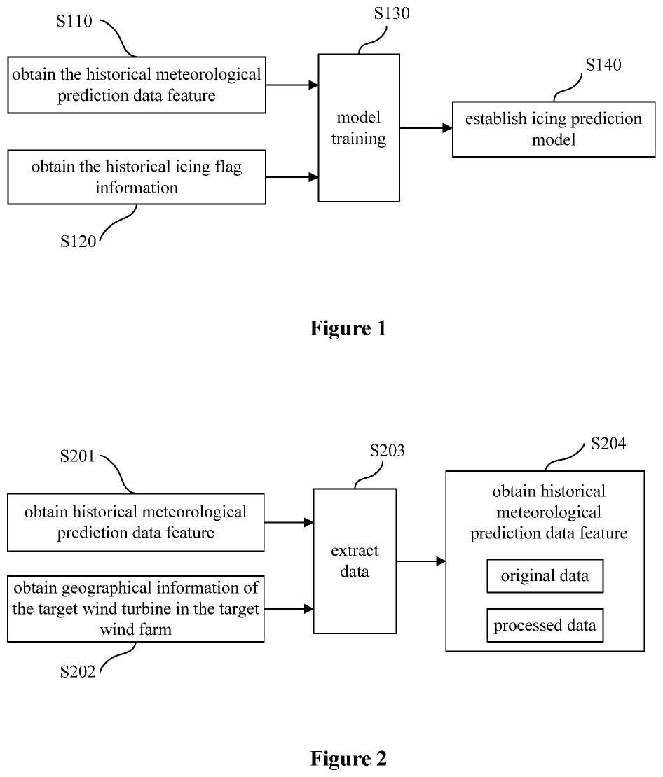

FIG. 1 is a schematic diagram of a method for generating an icing prediction model of a wind turbine generator system according to an embodiment of the present application.

As shown in FIG. 1, the method for generating the icing prediction model of the wind turbine generator system includes the following steps S110 to S140. In step S110, a historical meteorological prediction data feature is obtained. In step S120, historical icing flag information is obtained. In step S130, model training is performed based on the historical meteorological prediction data feature and the historical icing flag information. In step S140, an icing prediction model is obtained based on the training.

In step S110, the historical meteorological prediction data feature may be extracted from global meteorological data.

In step S120, an obtaining manner of the historical icing flag information of a wind turbine may include the following two manners.

In a first manner, the historical icing flag information is obtained by a hardware feedback from an icing sensor provided with the wind turbine; and

In a second manner, the historical icing flag information is obtained by analyzing operation data of the wind turbine base on an icing mechanism.

For the second manner, the blade shape may be changed by an ice coating according to the icing mechanism. A drag force of the blade increases, a lift force of the blade decreases, thereby the blade enters a stall state. In such case, the generating capacity of the wind turbine decreases, which is directly reflected in an abnormal relationship between a wind speed and a power. A basic formula for determining the abnormal relationship may be Formula 1 shown as follows.

$${P}_{r} < \frac{{C}_{p} ρ A {V}^{3}}{2} \times α \qquad ( Formula 1 )$$

In the Formula 1, Pᵣ denotes an actual generated power (kW); Cₚ denotes a wind power utilization coefficient; ρ denotes an air density, which is 1.23 kg/m³ or estimated by an altitude and an ambient temperature; A denotes a wind swept area calculated by an impeller diameter; V denotes a wind speed; ½ is a coefficient; α denotes a threshold ranged from 0 to 1, and a typical value of α may be 0.65. The product of ½ and α may be a coefficient threshold ranged from 0 to ½. The coefficient threshold may be obtained from a large number of experimental data.

In some embodiments, in a case where (1) the actual generated power is low and meets the Formula 1, (2) situation (1) lasts for a preset time (such as 2 min), (3) the ambient temperature meets an icing condition and (4) there is no other power abnormality warning, the icing flag of the wind turbine may be set as 1, that is, the state of the wind turbine is an icing state.

In some embodiments, when the formula 1 is used to obtain the icing flag of the wind turbine, the triggering condition for obtaining the icing flag of the wind turbine may be adjusted based on a tolerance of the blade icing or based on other factors.

In some embodiments, the icing flag information may be represented by a Boolean value of 0 or 1. For example, when the icing flag is 1, it indicates that the wind turbine generator system is frozen. When the icing flag is 0, it indicates that the wind turbine generator system is not frozen.

In some embodiments, the icing flag information (abbreviated as a flag or a label) may also be represented by an analog value (For example, in Formula 1, the flag is 0.1 when α is 0.65, the flag is 0.2 when α is 0.60, the flag is 0.3 when α is 0.55, the rest may be deduced in a same manner). The analog value may represent a difference in a thickness of the icing.

In some embodiments, in addition to the above method of comparing the wind speed with the power, a second method of generating the flag may be adopted. The flag is generated based on an abnormal relationship between a wind speed and an impeller speed in a case where the icing causes the blade to be in a stall. Alternatively, multivariate data is inputted into a flag generating model through using a machine learning method, and a training is performed thereon to obtain an icing detection model for outputting the icing flag.

In S130, the model training condition according to an embodiment may include: meteorological prediction data feature and icing flag information of each of wind turbines in a target wind farm for a historical time period are obtained. Model training based on the historical meteorological prediction data feature and the historical icing flag information (called a sample data) may be a supervised learning. Sample data may be divided into a training data set and a test data set. The training data set may include historical meteorological prediction data feature of half the wind turbines in the target wind farm, and a corresponding historical icing flag information of said wind turbines. A decision tree method using an R language may be applied in the model training, details of which may be shown in Formula 2 below.

band_Clas<-rpart(state˜.,Train_ice,method=“class”,minsplit=8) (Formula 2)

In some embodiments, a regression method may be applied in the model training.

In some embodiments, a feature screening may be performed firstly and then a dimensionality reduction on multiple features may be performed in the model training.

In some embodiments, wind turbines having a higher icing frequency may be selected for the model training, so as to solve a sample imbalance problem of the training.

In some embodiments, random forest or other machine learning algorithms may be used to perform the model training.

In some embodiments, the objective of the model training may be to obtain the icing prediction model based on the feature (such as the historical meteorological prediction data feature) and the flag.

In some embodiments, the Python language, the Matlab language or other modeling language may be applied in the model training. In such case, the expression of the Formula 2 should vary accordingly.

In some embodiments, a model test may be performed based on randomly selected training data set and test data set, or may be performed by a k-fold cross-validation method.

In S140, the icing prediction model can be obtained by the above Formula 2. In this embodiment, the sample for model training may include multiple data sets, such as a data set M composed of original data (which may include original meteorological data feature) and a processed data set N which is obtained by processing a data set M. The processing may include a data deletion processing and a data format unifying processing. Each data set may include one or more data subsets. For example, the data set M may include a subset M′, and the data set N may include a subset N′, and the like.

In this embodiment, in a case that the sample for the model training is sufficient, the establishing of the icing prediction model may be finished by performing an optimization and based on test data set of the other half wind turbines. The input of the icing prediction model may include a subset M′ including an original feature (raw data) of the meteorological data, and a subset N′ obtained by performing processing on original variables. Since the training data set and the test data set in this embodiment are taken from the entire wind farm, the icing prediction model can output the icing flag information of each of the wind turbines in the wind farm. FIG. 2 is a schematic diagram of obtaining a historical meteorological prediction data feature according to an embodiment of the present application.

As shown in FIG. 2, the obtaining a historical meteorological prediction data feature (that is, step S110) may include the following steps S201 to S 204. In S201, historical global meteorological data is obtained. In S202, geographic information of each of wind turbines (wind turbine generator system) in a target wind farm is obtained. In S203, data are extracted from the historical global meteorological data. In S204, the historical meteorological prediction data feature is obtained.

In S201, the historical global meteorological data may be obtained by performing a simulation on weather forecasts of a certain historical time period (e.g., the twelfth lunar month of the last year) for the target wind farm using a weather mode. Specifically, a parameterization scheme, a simulation range and a nesting manner which are suitable for the topographical and climatic features of a region where the wind farm is located may be selected, so as to perform a numerical forecast on the weather condition of the wind farm. To select a suitable parameterization scheme for a region, local weather characteristics should be taken into account for the selection. For example, for the plateaus with complex topography and high altitude which has a relatively strong convection, microphysics and a cumulus convection parameterization process are important for a simulation precision. For a mountain region with variable weather, a planetary boundary layer parameterization scheme is more important. For a water-land junction region such as a coast and a lakeside, a land surface parameterization scheme is more important. In addition, parameterization schemes of microphysics, turbulence, diffusion, long-wave radiation, short-wave radiation, etc. are also important options of parameterization scheme. Since there are hundreds of parameterization options in a meteorological mode, details of which are omitted herein.

For different wind farms, different parameterization schemes may be combined for forecasting. The combined scheme is obtained by summarizing a comparison result between multiple simulations based on local weather features and real measured data. Hereinbefore, the main principles for selecting a parameterization scheme are described. The parameterization scheme may be selected based on the principles and an experience from historical simulating data of the region. The simulation range and the nesting manner are mainly determined by factors such as the size of the wind farm and a required resolution of final data. A final numerical forecast of the target wind farm may include more than one hundred kinds of variables, such as a latitude and a longitude, horizontal and vertical wind speeds, a dry air quality of perturbation, a perturbation pressure, a surface heat flux, a temperature, and a water-gas mixing ratio.

In some embodiments, for a numerical simulation performed based on global meteorological data, the modes used may be commonly used mesoscale numerical modes, such as a Weather Research and Forecasting Mode (WRF), mesoscale non-hydrostatic force mode (Mesoscale Mode version 5, MM5) and a Regional Atmospheric Modeling System (RAMS). In addition, other numerical modes capable of simulating or forecasting, such as various climate modes, ocean modes, ocean-air coupled modes may be used. Alternatively, various prediction models, such as models using a linear regression, multivariate regression, an artificial neural network, a support vectors machine, and a Bayes model may be used to perform a simulation or forecast on the global meteorological data.

In S202, the geographic information may be obtained from wind farm archive information, and the geographic information of the wind turbines may be obtained by any other means such as a satellite image recognition, a drone technology, and a relative position calibration between the wind turbines. The geographical information may be refined to the longitude, latitude and altitude of a position of each of the wind turbines.

In S203, a typical meteorological feature associated with an icing of the target wind farm relates to the topographic and climatic features of the target wind farm. Therefore, the typical meteorological feature associated with icing of the target wind farm is obtained based on the topographic and climatic features of the target wind farm, and the global meteorological data of the wind farm is extracted based on the typical meteorological feature.

The meteorological prediction data (that is, the historical meteorological prediction data feature), which are associated with icing of each of the wind turbines in the target wind farm, are extracted from the historical global meteorological data based on the geographic information including the longitude and latitude. The method for extracting data may be an inverse distance weighting interpolation method, a modified Shepard's method, a bilinear interpolation method, a natural neighbor interpolation method, and a moving average method, and the like.

In S204, the historical meteorological prediction data feature may include original data and processed data. The original data may be original meteorological data feature, and may be specifically defined as a set M, including features M1, M2 . . . Mm. The processed data may be a feature set N, which is obtained by processing the original data, including features N1, N2 . . . Nn.

In some embodiments, the method for obtaining meteorological prediction data feature may be related to the knowledge of a technician on the icing phenomenon, or may be related to objective conditions such as different types of wind turbines, weather conditions, and topographic conditions. Set M, set, and subset M′, subset N′ for different target wind farms may be inconsistent with each other due to the difference in the above described factors.

In some embodiments, the obtaining historical meteorological prediction data feature of the target wind turbine may include: obtaining a topographic feature and climatic feature of the target wind farm where the target wind turbine is located; obtaining historical global meteorological data of the target wind farm; and extracting the historical meteorological prediction data feature from the historical global meteorological data, based on the topographic feature and the climatic feature.

According to the above embodiments, the icing information of the target wind turbine can be predicted actively and precisely based on the valid topographic prediction data feature, which is obtained, through the simulation training, of the wind turbines at different geographical locations, so that the operation and maintenance works for preventing icing on the wind turbines can be performed in a good time, thereby avoiding a potential economic loss caused by a passive icing treatment.

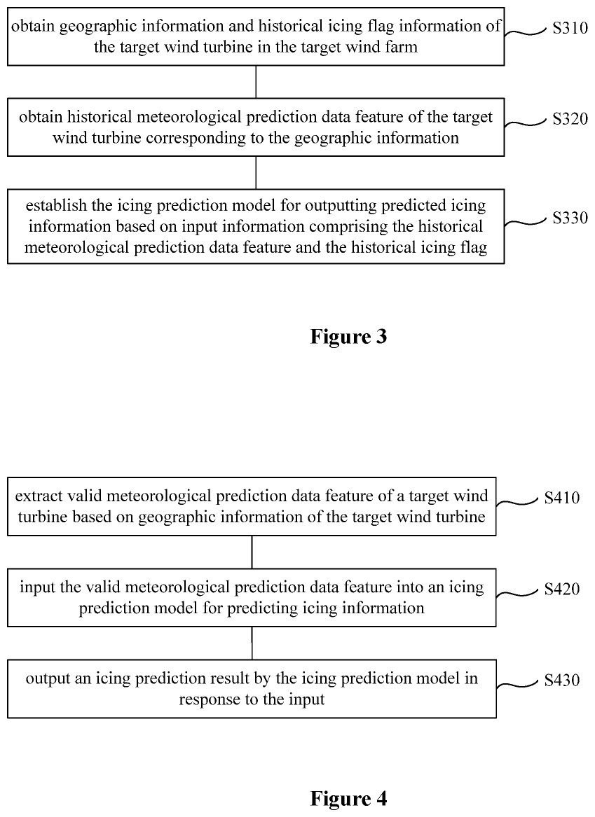

FIG. 3 is a schematic diagram of a method for generating an icing prediction model of a wind turbine generator system according to another embodiment of the present application.

As shown in FIG. 3, the method for generating the icing prediction model of the wind turbine generator system may include the following steps S310 to S330. In S310, geographic information and historical icing flag information of a target wind turbine in a target wind farm is obtained. In S320, a historical meteorological prediction data feature corresponding to the geographic information of the target wind turbine is obtained. In S330, an icing prediction model for outputting predicted icing information is established based on input information comprising the historical meteorological prediction data feature and the historical icing flag.

In some embodiments, the obtaining the historical meteorological prediction data feature corresponding to the geographic information of the target wind turbine in a preset time period (i.e., step S320) may include: obtaining topographic characteristic data and climate characteristic data of the target wind turbine, based on the geographic information; obtaining the historical global meteorological data of the target wind farm in the preset time period; extracting the historical meteorological prediction data feature from the historical global meteorological data based on the topographic characteristic data and the climate characteristic data.

In S310, the obtaining the historical icing flag information of the target wind turbine in the target wind farm may include: determining a historical reference power of the target wind turbine, based on a coefficient threshold and a wind power utilization coefficient, an air density, a wind swept area of an impeller, and a wind speed corresponding to the target wind turbine in a preset time period; obtaining a historical actual power of the target wind turbine monitored in the preset time period; comparing the historical actual power with the historical reference power, and determining the historical icing flag information of the target wind turbine based on a comparison result. In this embodiment, the comparison result may include: (1) the historical actual power is less than the historical reference power; or (2) the historical actual power is greater than or equal to the historical reference power. In a case that the historical actual power is less than the historical reference power, it indicates that power generated by the target wind turbine is reduced due to the icing. In such case, the historical icing flag is marked as an icing state. In some embodiments, the historical reference power may be determined as a product of the coefficient threshold, the wind power utilization coefficient, the air density, the wind swept area of the impeller and the wind speed.

In some embodiments, the coefficient threshold may be between 0 and ½.

In some embodiments, the obtaining the historical icing flag information of the target wind turbine may include: obtaining icing sensing data acquired by a sensor arranged on the target wind turbine; and obtaining the historical icing flag information of the target wind turbine based on the icing sensing data.

In S320, the historical meteorological prediction data feature may include original data in the historical global meteorological data, and/or the processed data obtained by processing the original data. Therefore, the original data and the processed data in the embodiment of the present application may be used as the historical meteorological prediction data feature, so that an issue that a poor pertinence due to using the original data alone and a large deviation due to using the processed data alone can be addressed. A data basis for a precision of a later prediction is provided, thereby ensuring a accurate prediction of icing information later.

In some embodiments, the historical meteorological prediction data feature includes one or more of the following parameters: microphysical parameters, cumulus convection parameters, planetary boundary layer parameters, land surface parameters, turbulence parameters, diffusion parameters, and radio wave radiation parameters. Where the historical meteorological prediction data feature may be all meteorological data that is finally output or intermediately output in a numerical mode. The historical meteorological prediction data feature may also include parameters other than the microphysical parameters, the cumulus convection parameters, the planetary boundary layer parameters, the land surface parameters, the turbulence parameters, the diffusion parameters, and the radio wave radiation parameters.

In S330, the generating the icing prediction model may include: determining the historical meteorological prediction data feature and the historical icing flag information as sample data; dividing the sample data into a training data set and a test data set; training the training data set by a supervised machine learning method, so as to obtain a basic meteorological preset data feature; and testing the basic meteorological preset data feature by using the test data set to obtain the icing prediction model which predicts icing information based on valid meteorological prediction data feature. Therefore, the prediction and the test can be combined perfectly through the training data set and the test data in the embodiment of the present application, so that the precision of the icing prediction can be further improved.

In some embodiments, the generation method of a model may further include: obtaining topographic characteristic data and/or climate characteristic data of each of the target wind turbines in the target wind farm; clustering the historical meteorological prediction data feature based on the topographic characteristic data and/or the climate characteristic data; and training, based on the historical icing flag information and the clustered historical meteorological prediction data feature, to obtain the icing prediction model which predicts the icing information based on the valid meteorological forecasting data feature. Therefore, the training can be more targeted by the method of clustering data in the embodiment of the present application, which can not only improve the training accuracy and in turn improve the accuracy of the icing prediction, but also can reduce the data computation, the computational overhead and save the training time.

In some embodiments, a clustering should be performed first, and then models for different clusters are established according to the method of the above embodiment, in a case that the number of wind turbines in the target wind farm is huge and the distribution thereof is relatively scattered or the difference between topographies of different wind turbines is large.

In some embodiments, in a case that there is only one wind turbine in the target wind farm, the model is established in a time dimension, that is, based on the training set data comprising data in a part of the time period and the test set data comprising data in another part of the time period.

Specifically, since the numerical weather forecast usually covers an area of hundreds of kilometers, all the wind turbines in a simulated area may be clustered, in a case that there is multiple target wind farms in the simulated area of the numerical forecast, and there is one or more wind turbines in each of the multiple target wind farms. The principles for clustering may include topographic conditions and local meteorological conditions. The topographic conditions includes an altitude, a roughness, a ruggedness index, and the local meteorological conditions includes convection intensity, an atmospheric stability, a turbulence intensity, a wind speed, a wind direction, etc., A model is then established in the manner of the above embodiment based on different clusters. The icing prediction model established in this embodiment can be provided to multiple target wind farms within the scope of the numerical weather prediction.

In some embodiments, the method of generating a model may further include: obtaining an operating parameter of a target wind turbine; and training, based on the operating parameter, the historical meteorological prediction data feature and the historical icing flag information, to obtain the icing prediction model which predicts the icing information based on the valid meteorological prediction data feature. According to the embodiment of the present application, a targeted training can be performed, based on the operating parameters of the target wind turbine, the historical meteorological prediction data feature and the historical icing flag information so as to obtain a prediction model that is highly matched with the target wind turbine, thereby greatly improving the precision of the icing prediction.

In some embodiments, the operating parameters may include: a blade speed, a pitch angle and a generated power.

FIG. 4 is a schematic diagram of a method for predicted icing on a wind turbine generator system according to an embodiment of the present application.

As shown in FIG. 4, a wind turbine icing prediction method for predicting icing on the wind turbine may include the following steps S410 to S430. In S410, a valid meteorological prediction data feature of a target wind turbine is extracted based on geographic information of the target wind turbine. In S420, the valid meteorological prediction data feature is inputted into an icing prediction model for predicting icing information; S430, outputting an icing prediction result by the icing prediction model in response to the input.

In some embodiments, the extracting the valid meteorological prediction data feature of the target wind turbine based on the geographic information of the target wind turbine (S410) may include: obtaining global meteorological data of a target wind farm where the target wind turbine is located; obtaining geographic information of each of wind turbines in the target wind farm; and extracting, from the global meteorological data based on the geographic information of each of the wind turbines, the valid meteorological prediction data feature associated with an icing of each of wind turbines.

In some embodiments, the valid meteorological prediction data feature may include an original meteorological data feature, and/or a processed feature obtained by processing the original meteorological data feature.

In some embodiments, the method of extracting the valid meteorological prediction data feature of the target wind turbine includes one or more of the following methods: an inverse distance weighting interpolation method, a modified Shepard's method, a bilinear interpolation method, a natural neighbor interpolation method, and a moving average method.

In some embodiments, the obtaining global meteorological data of a target wind farm where the target wind turbine is located may include: obtaining a topographic feature and a climatic feature of the target wind farm; determining the global meteorological data including a parameterization scheme, based on the topographical feature and the climatic feature, to perform a numerical weather prediction for the target wind farm.

In some embodiments, the method for predicting icing on the wind turbine generator system may further include: obtaining a historical meteorological prediction data feature and a historical icing flag; and establishing the icing prediction model for outputting predicted icing information based on input information comprising the historical meteorological prediction data feature and the historical icing flag.

In some embodiments, the establishing the icing prediction model for outputting predicted icing information based on input information comprising the historical meteorological prediction data feature and the historical icing flag may include: dividing the input information into a training data set and a test data set; training, by a supervised machine learning method, the training data set; performing a test on the trained training data set by using the test data set to obtain a test result; and establishing the icing prediction model based on the test result.

In some embodiments, the dividing the input information into a training data set and a test data set may include the followings. In a case that there are multiple target wind turbines, the multiple target wind turbines are clustered, based on the topographic conditions and/or the meteorological conditions of the multiple target wind turbine, to generate wind turbines of a first type and wind turbines of a second type. Input information of the wind turbines of the first type is determined as the training data set; and input information of the wind turbines of the second type is determined as the test data set.

In some embodiments, the dividing the input information into a training data set and a test data set may include the followings. In a case that there is only one target wind turbine, input information of the target wind turbine in a first period is clustered into a training data set, and input information of the target wind turbine in a second period is clustered into a test data set.

According to the above embodiment, the data set is more targeted and more accurate since a clustering is performed, which may facilitate a subsequent accurate icing prediction for any number of wind turbines in any wind farm.

In some embodiments, the obtaining the historical meteorological prediction data feature of the target wind turbine may include: obtaining topographic feature and climatic feature of a target wind farm where the target wind turbine is located; obtaining historical global meteorological data of the target wind farm; and extracting the historical meteorological prediction data feature from the historical global meteorological data, based on the topographic feature and the climatic feature.

In some embodiments, the obtaining the historical icing flag of the target wind turbine includes: determining whether the temperature and humidity meet the icing condition; determining whether an operating parameter of the target wind turbine is abnormal in a case that a temperature and a humidity meet an icing condition; and obtaining the historical icing flag of the target wind turbine in a case that the operating parameter of the target wind turbine is abnormal. The above icing prediction model of the target wind turbine is applied to predict the icing information of the target wind turbine in the embodiment of the present application. An application scenario is to display the predicted the icing information (such as the icing flag) in a monitoring system of a wind farm owner. The predicted icing information may be an indication of whether the target wind turbine is in an icing state after a preset time (for example, after 6 hours). For example, a flag for a fully icing is 1, a flag for no icing is 0, and a flag for relatively thin icing is 0.1 and a flag for a very thick icing is 0.9. The predicted icing information may also be a curve showing an icing possibility of the target wind turbine.

In some embodiments, the predicted icing information may be outputted to multiple systems and incubate corresponding services, such as application scenarios that a core variable for an icing prediction service of a regional multi-wind farm scheduling system; or, an input variable for a dynamic operation and maintenance decision system.

It should be noted that an executive subject of the above method may be a processor or a controller and the like. In a case of no conflict, those skilled in the art can flexibly adjust the sequence of the above processing steps according to actual needs, or flexibly combining the above steps. For the sake of brevity, various implementations are omitted herein. In additional, the contents of the embodiments may be referred to each other.

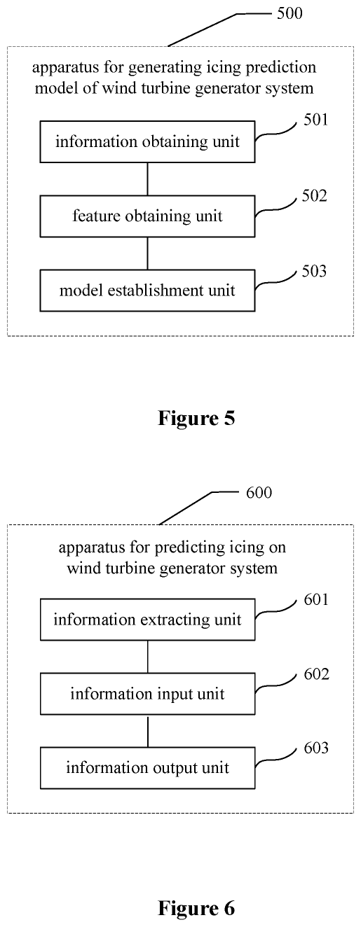

FIG. 5 is a structure schematic diagram of an apparatus for generating an icing prediction model of a wind turbine generator system according to an embodiment of the present application.

As shown in FIG. 5, an apparatus 500 may include: an information obtaining unit 501, a feature obtaining unit 502 and a model establishment unit 503. The information obtaining unit 501 may be configured to obtain geographic information and historical icing flag information of a target wind turbine in a target wind farm. The feature obtaining unit 502 may be configured to obtain a historical meteorological prediction data feature of the target wind turbine corresponding to the geographic information; the model establishment unit 503 may be configured to establish the icing prediction model for outputting predicted icing information based on input information comprising the historical meteorological prediction data feature and the historical icing flag.

In some embodiments, the information obtaining unit 501 may be configured to: obtain topographic characteristic data and climate characteristic data of the target wind turbine based on the geographic information; obtain historical global meteorological data of the target wind farm in a preset time period; and extract the historical meteorological prediction data feature from the historical global meteorological data, based on the topographic characteristic data and the climate characteristic data.

In some embodiments, the historical meteorological prediction data feature may include original data in the historical global meteorological data and/or processed data obtained by processing the original data.

In some embodiments, the historical meteorological prediction data feature includes one or more of the following parameters: microphysical parameters, cumulus convection parameters, planetary boundary layer parameters, land surface parameters, turbulence parameters, diffusion parameters, and radio wave radiation parameters.

In some embodiments, the information obtaining unit 501 may be further configured to: determine a historical reference power of the target wind turbine, based on a coefficient threshold and a wind power utilization coefficient, an air density, a wind swept area of an impeller, and a wind speed corresponding to the target wind turbine in a preset time period; obtain a historical actual power of the target wind turbine monitored in the preset time period; compare the historical actual power with the historical reference power, and determine the historical icing flag information of the target wind turbine based on the comparison result.

In some embodiments, the information obtaining unit 501 may be further configured to: determine the historical reference power as a product of the coefficient threshold, the wind power utilization factor, the air density, the wind swept area of an impeller and the wind speed.

In some embodiments, the coefficient threshold may be between 0 and ½.

In some embodiments, the information obtaining unit 501 may be further configured to: obtain icing sensing data collected by a sensor arranged on the target wind turbine; and obtain the historical icing flag information of the target wind turbine based on the icing sensing data.

In some embodiments, the model establishment unit 503 may be further configured to: determine the historical meteorological prediction data feature and the historical icing flag information as sample data; divide the sample data into a training data set and a test data set; train the training data set, based on the supervised machine learning method, to obtain the basic meteorological preset data feature; and test the basic meteorological preset data feature using the test data set to obtain the icing prediction model, which predicts the icing information based on the valid meteorological prediction data feature.

FIG. 6 is a structure schematic diagram of an apparatus for predicting icing on a wind turbine generator system according to an embodiment of the present application.

As shown in FIG. 6, an apparatus 600 may include an information extracting unit 601, an information input unit 602 and an information output unit 603. The information extracting unit 601 may be configured to extract a valid meteorological prediction data feature of a target wind turbine based on geographic information of the target wind turbine. The information input unit 602 may be configured to input the valid meteorological prediction data feature into an icing prediction model for predicting icing information. The information output unit 603 may be configured to output an icing prediction result by the icing prediction model in response to the input.

In the present embodiment, an icing prediction flag for prediction is generated by performing a computation based on real-time meteorological prediction data feature using the icing prediction model as shown in FIG. 6. The computing environment for the icing prediction model may be a central monitoring system of a wind farm owner, or a computer in a remote monitoring center, or other machines having a computing capability.

In some embodiments, the icing prediction model may output a curve showing an icing possibility after 6 hours in the monitoring system of the wind farm owner.

In some embodiments, the apparatus 600 may further include a feature clustering unit. The feature clustering unit may be configured to: obtain topographic characteristic data and/or climate characteristic data of each of target wind turbines in the target wind farm; perform a clustering on the historical meteorological prediction data feature based on the topographic characteristic data and/or the climate characteristic data; and perform a training based on the historical icing flag information and the clustered historical meteorological prediction data feature, so as to obtain the icing prediction model which predicts the icing information based on the valid meteorological forecasting data feature.

In some embodiments, the apparatus 600 may further include an optimization training unit. The optimization training unit may be configured to: obtain an operating parameter of the target wind turbine; and perform a training based on the operating parameter, the historical meteorological prediction data feature and the historical icing flag information, so as to obtain the icing prediction model which predicts the icing information based on the valid meteorological forecasting data feature.

In some embodiments, the operating parameters may include a blade speed, a pitch angle and a generated power.

Units in the above embodiments may be integrated in one processing unit, or the units each may be a physically separate unit, or two or more of the units may be integrated into one unit. The above integrated unit may be realized in a form of hardware or in a form of software process unit.

It should be noted that, the apparatus in the above embodiments can serve as the executive subject for performing corresponding methods of the embodiments, which can implement the corresponding processes in each of the corresponding methods and achieve the same technical effect. For the sake of brevity, these contents are omitted herein.

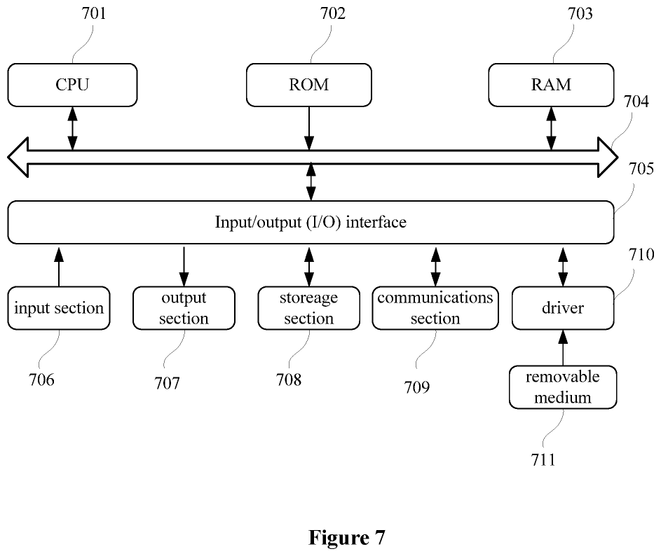

FIG. 7 is an architecture schematic diagram of an apparatus for predicting icing on a wind turbine generator system according to an embodiment of the present application.

As shown in FIG. 7, e a central processing unit (CPU) 701 is included in the architecture, which may execute various operations in embodiments of FIG. 1, FIG. 2, FIG. 3, and FIG. 4, based on a program stored in a Read Only Memory (ROM) 702 or a program in a Random Access Memory (RAM) 703 which is read from a storage section 708. In the RAM 703, various programs and data required by system architecture operations are also stored. The CPU 701, the ROM 702 and the RAM 703 are connected to each other through a bus 704. Input/output (I/O) interface 705 is also connected to the bus 704.

The following elements are connected to I/O interface 705: an input section 706 including a keyboard and a mouse; an output section 707 including elements such as a Cathode Ray Tube (CRT), a Liquid Crystal Display (LCD) and a speaker; a storage section 708 including a hard disk; and a communication section 709 including a network interface card such as a LAN card and a modem. The communication section performs a communication process via a network such as the Internet. The driver 710 may also be connected to the I/O interface 705 if needed. A removable medium 711, such as a magnetic disk, an optical disk, a magneto-optical disk, and a semiconductor memory, may be mounted on the drive 710 as needed, such that a computer program may be read out therefrom and may be stored in the storage section 708 as needed.

In an embodiment of the present application, the process described above in conjunction with figures may be implemented as a computer program. In such an embodiment, the computer program may be downloaded and installed from the network via the communication section 709, and/or installed from the removable media 711.

The apparatus embodiments described above are only illustrative, in which various units that are described as separate components may be or not be separated physically. Elements described as units may be or not be physical units, i.e., the elements may be located at one place or distributed in multiple network units. A part of or all the units may be selected to achieve the objective of the solution of the present embodiment based on actual needs, which may be understood and implemented by those skilled in the art without any creative work.

Through the foregoing descriptions of the embodiments, it is clear to a person skilled in the art that the implementations may be implemented by software and a necessary universal hardware platform, and or may be implemented by hardware. Based on this, the s essential technical features, in other words, a portion of the technical solutions of the present application contributing to the conventional technology may be implemented as a software product. The software product, which may be stored in a computer readable storage medium, such as ROM/RAM, a diskette or an optical disk, includes instructions to enable a computer device (such as a personal computer, a server and a network device) to perform the method described in each of the embodiments or methods described in parts of the embodiments.

It should be noted that the above embodiments are merely provided for a purpose for illustrating the technical solutions of the present application and is not intended to limit the application. Although the present application has been described in detail in reference to the embodiments, various modifications, or equivalent substitutions for parts of the technical features may be made by those skilled in the art to the technical solutions of the present application without departing from the spirit and scope of the technical solutions of the present application.

1. A method for predicting icing on a wind turbine generator system, comprising:
extracting a valid meteorological prediction data feature of a target wind turbine based on geographic information of the target wind turbine;
inputting the valid meteorological prediction data feature into an icing prediction model for predict icing information; and
outputting an icing prediction result by the icing prediction model in response to the input.

2. The method according to claim 1, wherein the extracting a valid meteorological prediction data feature of a target wind turbine based on geographic information of the target wind turbine comprises:
obtaining global meteorological data of a target wind farm where the target wind turbine is located;
obtaining geographic information of each of wind turbines in the target wind farm; and
extracting, from the global meteorological data based on the geographic information of each of the wind turbines, the valid meteorological prediction data feature associated with an icing of each of wind turbines.

3. The method according to claim 1, wherein the valid meteorological prediction data feature comprises:
an original feature of meteorological data and/or a processed feature obtained by processing the original feature of the meteorological data.

4. The method according to claim 1, wherein the extracting a valid meteorological prediction data feature of a target wind turbine based on geographic information of the target wind turbine is executed by one or more of the following methods:
an inverse distance weighting interpolation method, a modified Shepard's method, a bilinear interpolation method, a natural neighbor interpolation method, and a moving average method.

5. The method according to claim 2, wherein the obtaining global meteorological data of a target wind farm where the target wind turbine is located comprises:
obtaining a topographic feature and a climatic feature of the target wind farm; and
determining the global meteorological data comprising a parameterization scheme based on the topographic feature and the climatic feature, to perform a numerical weather prediction for the target wind farm.

6. The method according to claim 1, further comprising:
obtaining a historical meteorological prediction data feature and a historical icing flag of the target wind turbine in advance; and
establishing the icing prediction model for outputting predicted icing information based on input information comprising the historical meteorological prediction data feature and the historical icing flag.

7. The method according to claim 6, wherein the establishing the icing prediction model for outputting predicted icing information based on an input comprising the historical meteorological prediction data feature and the historical icing flag comprises:
dividing the input information into a training data set and a test data set;
training, by a supervised machine learning method, the training data set; performing a test on the trained training data set by using the test data set to obtain a test result; and
establishing the icing prediction model based on the test result.

8. The method according to claim 6, wherein the dividing the input information into a training data set and a test data set comprises the following steps:
in a case where there is a plurality of target wind turbines, the method comprises:
clustering the plurality of the target wind turbines based on topographic conditions and/or meteorological conditions of the plurality of the target wind turbines to generate wind turbines of a first type and wind turbines of a second type;
determining the input information of the wind turbines of the first type as the training data set; and
determining the input information of the wind turbines of the second type as the test data set;
or
in a case where there is only one target wind turbine, the method comprises:
clustering the input information of the target wind turbine in a first period into the training data set, and clustering the input information of the target wind turbine in a second period into the test data set.

9. The method according to claim 6, wherein the obtaining the historical meteorological prediction data feature of the target wind turbine comprises:
obtaining a topographic feature and a climatic feature of a target wind farm where the target wind turbine is located;
obtaining historical global meteorological data of the target wind farm; and
extracting the historical meteorological prediction data feature from the historical global meteorological data based on the topographic feature and the climatic feature.

10. The method according to claim 6, wherein the obtaining the historical icing flag of the target wind turbine comprises:
determining whether a temperature and humidity meet an icing condition;
determining whether an operating parameter of the target wind turbine is abnormal in a case that the temperature and the humidity meet the icing condition; and
obtaining the historical icing flag of the target wind turbine in a case that the operating parameter of the target wind turbine is abnormal.

11. (canceled)

12. An apparatus for predicting icing on a wind turbine generator system, comprising:
at least one processor, at least one memory storing a computer program,
wherein the computer program, when being executed by the processor, cause the processor to perform the method according to claim 1.

13. A computer readable storage medium which stores a computer program, wherein the computer program, when being executed by a processor, cause the processor to perform the method according to claim 1.

14-15. (canceled)
